(19) United States
(12) Patent Application Publication
(10) Pub. No.: US 2007/0282090 A1
(43) Pub. Date: Dec. 6, 2007

(54) ADDITIVES FOR TWO-COMPONENT POLYURETHANE

(76) Inventors: Petra Padurschel, Duesseldorf (DE); Rolf Tenhaef, Duesseldorf (DE); Olaf Lammerschop, Krefeld (DE); Thomas Huver, Duesseldorf (DE); Hubert Schenkel, Sandhausen (DE); Andreas Ferencz, Duesseldorf (DE)

Correspondence Address: HENKEL CORPORATION, THE TRIAD, SUITE 200, 2200 RENAISSANCE BLVD., GULPH MILLS, PA, 19406, US

(21) Appl. No.: 11/753,971

(22) Filed: May 25, 2007

Related U.S. Application Data
(63) Continuation of application No. PCT/EP05/12422, filed on Nov. 21, 2005.

(30) Foreign Application Priority Data
Nov. 30, 2004 (DE) 10 2004 057 699.8

(51) Int. Cl. C08G 18/00

(52) U.S. Cl. 528/44

(57) ABSTRACT

The invention relates to a two-component polyurethane adhesive based on a polyol component and a polyisocyanate component. An adhesive bond produced using the adhesive between two steel panels coated with cathodic electrocoat has, at a temperature of −40° C., an impact peel strength as measured by ISO 11343 of at least 11 N/mm. The invention further relates to an additive for polyurethane adhesives and also to the use of said additives.

### CROSS-REFERENCE TO RELATED APPLICATIONS

This application is a continuation under 35 U.S.C. § 365(c) and 35 U.S.C. § 120 of International application PCT/EP2005/012422, filed Nov. 21, 2005, and published Jun. 8, 2006, as WO 2006/058624, incorporated herein by reference in its entirety. This application also claims priority under 35 U.S.C. § 119 of DE 102004057699.8, filed Nov. 30, 2004, which is incorporated herein by reference in its entirety.

### FIELD OF THE INVENTION

The invention relates to a two-component polyurethane additive based on a polyol component and a polyisocyanate component. The invention also relates to an additive for such an adhesive and the use of the additive.

### DISCUSSION OF THE RELATED ART

Polyurethane adhesives are described for example in the following patent applications and patents: EP 0 504 436 B1, EP 0 411 432 B1, EP 0 442 084 B1, DE 40 33 221 A1, EP 0 597 636 B1, and EP 0 740 675 B1.

Polyurethane adhesives are long-established and wide-spread. Particularly important, especially in the context of industrial applications, are the two-component adhesives which the user prepares by stirring prior to use, to form a reaction mixture which then cures following application to the substrates that are to be bonded. Such two-component adhesives consist of a polyol component and an isocyanate component with a functionality of 2 or more. For numerous applications these adhesives are preferred over other adhesives since the adhesive bonds produced using them are of outstanding bond strength, flexibility, and resistance to shock and fatigue.

In mechanical, vehicular or instrumental engineering, particularly in aircraft, rail-vehicle or automobile construction, the components are increasingly being joined, from the various metallic components and/or composite materials, by means of adhesives. For structural adhesive bonds with exacting strength requirements, use has been widely made to date of epoxy adhesives, particularly in the form of hot-curing one-component adhesives, which are frequently also formulated as reactive hotmelt adhesives. Reactive hotmelt adhesives are solid at high temperatures. They soften at temperatures up to about 80-90° C. and behave like a thermoplastic material. Only at higher temperatures, above about 100° C., are the latent curing agents present in these hotmelt adhesives thermally activated, so that there is irreversible hardening to form a thermoset. For the joining of components, in the vehicle industry, for example, the adhesive is first applied warm to at least one substrate surface, and then the components to be connected are joined. In the course of cooling, the adhesive becomes rigid, and by virtue of this physical rigidification creates sufficient strength for handling, i.e., a provisional bond. The components bonded to one another in this way are further treated in various washing, phosphating, and dip coating baths. Only then is the adhesive cured in an oven at higher temperatures.

In deviation from this hitherto customary mode of working, there is a desire, particularly within the vehicle industry, to carry out the pretreatment of the components to be bonded, including the electrodeposition coating, before the parts are adhesively bonded. The intention, then, is to carry out adhesive bonding of metal parts which have a cured electrodeposition coating on their surface.

Although polyurethane adhesives provide outstanding adhesive bonds in numerous fields of use, the adhesives of this type that have been known to date are unsuited to the structural adhesive bonding of coated metal or composite workpieces, on account of their lack of adequate impact toughness at low temperatures.

### BRIEF SUMMARY OF THE INVENTION

It is an object of the present invention, therefore, to specify two-component polyurethane adhesives which have a high strength in the temperature range from −40° C. to +80° C. without undergoing embrittlement in the low-temperature range. The impact peel strength as measured by ISO 11343 can be considered a measure of the adhesive's impact toughness.

Surprisingly it has been found that the aforementioned object can be achieved by adding specific additives to two-component polyurethane adhesives that increase the impact toughness of the adhesive bonds.

The invention accordingly provides a two-component polyurethane adhesive, based on a polyol component and a polyisocyanate component, that is characterized in that an adhesive bond produced using the adhesive between two steel panels coated with cathodic electrocoat has, at a temperature of −40° C., an impact peel strength as measured by ISO 11343 of at least 11 N/mm. Two-component polyurethane adhesives having an impact peel strength of that order have not hitherto been disclosed.

### DETAILED DESCRIPTION OF CERTAIN EMBODIMENTS OF THE INVENTION

For the present invention the selection of the polyol component and the polyisocyanate component is not critical. Suitable polyol components include not only low molecular weight polyols but also high molecular weight polyols, examples being hydroxyl-bearing polyesters which have at least 2 hydroxyl groups per molecule. Suitable polyisocyanate components are the typical isocyanate curing agents for polyurethane adhesives, having at least 2 isocyanate groups per molecule. Examples of suitable polyol components are liquid polyhydroxy compounds having two or three hydroxyl groups per molecule, such as difunctional and/or trifunctional polypropylene glycols in the molecular weight range from 200 to 6000, preferably in the range from 400 to 3000, for example. Random and/or block copolymers of ethylene oxide and propylene oxide can also be used. A further group of polyether polyols whose use is preferred are the polytetramethylene glycols, prepared for example by the acidic polymerization of tetrahydrofuran, in which case the molecular weight range of the polytetramethylene glycols is preferably between 200 and 6000, more preferably in the range from 400 to 4000. Additionally suitable as polyols are the liquid polyesters which are preparable by condensing dicarboxylic and/or tricarboxylic acids, such as adipic acid, sebacic acid, and glutaric acid, for example, with low molecular weight diols and/or triols, such as ethylene glycol, propylene glycol, diethylene glycol, triethylene glycol, dipropylene glycol, 1,4-butanediol, 1,6-hexanediol, glycerol or trimethylolpropane, for example. A further group of polyols that can be used are the polyesters based on lactones, such as caprolactone or valerolactone. An alternative possibility is to use polyester polyols of oleochemical origin. Such polyester polyols can be prepared, for example, by complete ring opening of epoxidized triglycerides of a fatty mixture, containing at least partly olefinically unsaturated fatty acid, with one or more alcohols having 1 to 12 carbon atoms, followed by partial transesterification of the triglyceride derivatives to form alkyl ester polyols having 1 to 12 carbon atoms in the alkyl radical. Further suitable polyols are polycarbonate polyols and dimer diols, and also, in particular, castor oil and its derivatives. The hydroxy-functional polybutadienes as well, of the kind available, for example, under the trade name “Poly-BD”, can be used as polyols for the compositions of the invention. Suitable polyisocyanates are, for example, aromatic isocyanates, diphenylmethane diisocyanate for example, alternatively in the form of the pure isomers, as an isomer mixture of the 2,4′-/4,4′ isomers, or else the diphenylmethane diisocyanate (MDI) liquefied with carbodiimide, which is known, for example, under the trade name Isonate 143 L. It is possible, moreover, to use the so-called “crude MDI”, i.e., the isomer/oligomer mixture of MDI, of the kind obtainable commercially, for example, under the trade name PAPI or Desmodur VK. A further possibility is to use what are called quasi-prepolymers, i.e., reaction products of MDI and/or of tolylene diisocyanate (TDI) with low molecular weight diols such as, for example, ethylene glycol, diethylene glycol, propylene glycol, dipropylene glycol or triethylene glycol. Though the aforementioned isocyanates are the particularly preferred isocyanates, aliphatic and/or cycloaliphatic di- or polyisocyanates can be used as well, such as the hydrogenated MDI (H12 MDI), tetramethylxylylene diisocyanate (TMXDI), 1-isocyanatomethyl-3-isocyanato-1,5,5-trimethylcyclohexane (IPDI), hexane 1,6-diisocyanate (HDI), biuretization product of HDI, isocyanuratization product of HDI, or dimer fatty acid diisocyanate, for example.

Polyols are compounds having at least two hydroxyl groups. Suitable polyols are preferably the liquid polyhydroxy compounds having two or three hydroxyl groups per molecule, such as, for example, di- and/or trifunctional polypropylene glycols in a molecular weight range from 200 to 6000, preferably in the range from 400 to 3000. Random and/or block copolymers of ethylene oxide and propylene oxide can also be used. A further group of polyether polyols whose use is preferred are the polytetramethylene glycols, prepared for example by the acidic polymerization of tetrahydrofuran, in which case the molecular weight range of the polytetramethylene glycols is preferably between 200 and 6000, more preferably in the range from 400 to 4000. Additionally suitable as polyols are the liquid polyesters which are preparable by condensing dicarboxylic and/or tricarboxylic acids, such as adipic acid, sebacic acid, and glutaric acid, for example, with low molecular weight diols and/or triols, such as ethylene glycol, propylene glycol, diethylene glycol, triethylene glycol, dipropylene glycol, 1,4-butanediol, 1,6-hexanediol, glycerol or trimethylolpropane, for example. A further group of polyols that can be used are the polyesters based on lactones, such as caprolactone or valerolactone. An alternative possibility is to use polyester polyols of oleochemical origin. Such polyester polyols can be prepared, for example, by complete ring opening of epoxidized triglycerides of a fatty mixture, containing at least partly olefinically unsaturated fatty acid, with one or more alcohols having 1 to 12 carbon atoms, followed by partial transesterification of the triglyceride derivatives to form alkyl ester polyols having 1 to 12 carbon atoms in the alkyl radical. Further suitable polyols are polycarbonate polyols and dimer diols, and also, in particular, castor oil and its derivatives. The hydroxy-functional polybutadienes as well, of the kind available, for example, under the trade name “Poly-BD”, can be used as polyols for the compositions of the invention.

For the measurement of the impact peel strength, two specimens are bonded to one another. The adhesive seam, i.e., the joint, is loaded dynamically with a wedge which impinges on the joint at a defined speed. A measurement is made of the load under which the bond is parted.

The aforementioned impact peel strength value as measured by ISO 11343 is measured specifically under the following conditions:

The specimens consist of steel coated with cathodic electrocoat and have a size of 20×90 mm². The size of the bond area was 20×30 mm², and the thickness of the adhesive layer was 0.2 mm. The wedge had a length of 14 mm and a height of 4 mm. The angle between the faces of the wedge was 8° 46′ 18″. The wedge was moved with a speed of 2 m s⁻¹. These conditions apply to all of the impact peel strength values specified in this specification.

An adhesive bond produced using the adhesive advantageously has, at a temperature of −40° C., an impact peel strength as measured by ISO 11343 of at least 15 N/mm.

A two-component polyurethane adhesive which leads to the high impact peel strength stated can be achieved by its comprising, in addition to at least one polyol component and at least one polyisocyanate component, as additive at least one hydroxyl- or amine terminated reaction product of a compound having terminal hydroxyl or amino groups, of the general formula (I)
H—X—[—CH₂)ₘ—O—]ₙ—X′—H,
in which X is=—O— or 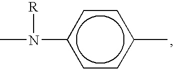
X′ is=a covalent bond or 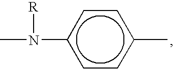
R being=H or a straight-chain or branched alkyl radical having 1 to 20 carbon atoms,
m is=3 or 4, and
n is=5 to 50,
with a di- or tricarboxylic acid or a di- or triisocyanate.

The additives are reactive prepolymers which, at the curing stage, react with the resin component of the adhesive, so that the additives are incorporated solidly into the polymer structure. As a result, soft phases are introduced into the adhesive assembly and result in the adhesive assembly retaining its integrity even in the event of a severe shock or impact. The soft phases absorb the energy of a shock, and the adhesive bond is impact-resistant.

The compound of the formula (I) used for preparing the additive is advantageously polytetrahydrofuran or polytetramethylene oxide-di-p-amino-benzene.

The dicarboxylic acid to be used is advantageously a dimerized fatty acid, and a preferred diisocyanate is diphenyl diisocyanate.

The adhesive of the invention contains the additive advantageously in an amount of 5-30% by weight, based on the total weight of said adhesive, preferably 10-20% by weight, with very particular preference 13-17% by weight.

The invention also provides the additive for two-component polyurethane adhesives that consists of a hydroxyl-terminated or an amine-terminated reaction product of a compound having terminal hydroxyl or amino groups, of the general formula (I)
H—X—[—CH₂)ₘ—O—]ₙ—X′—H,
in which X is=—O— or 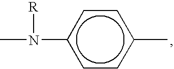
X′ is=a covalent bond or 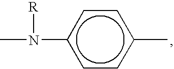
R being=H or a straight-chain or branched alkyl radical having 1 to 20 carbon atoms,
m is=3 or 4, and
n is=5 to 50,
with a di- or tricarboxylic acid or a di- or triisocyanate.

Advantageously the additive has a number-average molecular weight of 1000-20,000 g/mol, preferably 1000-12,000 g/mol, with very particular preference 2000-8000 g/mol.

The invention further provides for the use of a hydroxyl- or amine-terminated reaction product of a compound having terminal hydroxyl or amino groups, of the general formula (I)
H—X—[—CH₂)ₘ—O—]ₙ—X′—H,
in which X is=—O— or 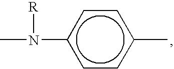
X′ is=a covalent bond or 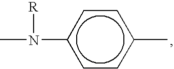
R being=H or a straight-chain or branched alkyl radical having 1 to 20 carbon atoms,
m is=3 or 4, and
n is=5 to 50,
with a di- or tricarboxylic acid or a di- or triisocyanate as an additive in two-component polyurethane adhesives for the purpose of enhancing the impact peel strength of adhesive bonds produced using the adhesives.

The invention is illustrated below using working examples.

### WORKING EXAMPLES

The experiments described below were carried out using the commercially available polyurethane additive TEROKAL 806 N from the company Henkel Teroson GmbH.

Basic formulation of the TEROKAL 806 N adhesive (base formula):

Component A (resin);

95% BAYCOLL VP 8576 (Bayer AG, polyol-based resin component)

5% BAYLITH Powder (Bayer AG, drier)

Component B (curing agent):

100% MAKROPLAST UK 5400 (Henkel KGaA, curing agent, diphenyl 4,4′-diisocyanate)

Mixing ratio: % by weight 1.3 (A):1 (B)

For the purpose of increasing the impact toughness, the additives were incorporated in the basic formula and bonding took place to cathodically electrocoated specimens. The adhesive assemblies were subjected to various destructive testing methods, such as tensile shear tests, peel tests, and impact peel tests.

### Example 1

Additive Synthesis:

Polytetramethylene oxide-di-p-aminobenzene and diphenyl 4,4′-diisocyanate are reacted by polyaddition to give a prepolymer. For this reaction 0.09 mol (111.4 g) of polytetramethylene oxide-di-p-aminobenzene is charged to a round-bottomed flask with gas inlet, condenser, and stirrer, and this initial charge is dried at 100° C. under a high vacuum for 1 hour with stirring. It is subsequently blanketed with nitrogen and cooled to 40° C. This is followed by the rapid addition of 0.06 mol (15.0 g) of diphenyl 4,4′-diisocyanate. After about 15 minutes the solution, which quickly becomes homogeneous, exhibits a gently exothermic reaction; the temperature rises to 47° C. At the same time there is a sharp rise in the viscosity, so that the reaction mixture solidifies to form an unstirrable, slightly elastic mass. Reaction of the reaction mixture continues at 100° C. for an hour, and then it is cooled to room temperature. The substance, which can no longer be melted, is cooled with liquid nitrogen and ground. The product takes the form of a fine, pale yellow powder which is soluble in acetone and has an amine number of 41.2 (additive 1).

Adhesive Formulation:

8 g of resin (see base formula)

2 g of additive 1

6.3 g of curing agent (see base formula)

This mixture is stirred intimately and quickly and bonding takes place to cathodically electrocoated specimens.

Results:

| | Room | | | . |
|---|---|---|---|---|
| | temperature | 0° C. | −20° C. | −40° C. |
| Impact peel | 26.3 N/mm | 25.8 N/mm | 22.8 N/mm | 14.2 N/mm |
| strength | | | | |

| | Room temperature | 80° C. |
|---|---|---|
| Tensile shear strength | 15.8 N/mm² | 13.8 N/mm² |

| | Room temperature |
|---|---|
| Peel strength | 6.7 N/mm |

### Example 2

Additive Synthesis:

Polytetramethylene oxide-di-p-aminobenzene and diphenyl 4,4′-diisocyanate are reacted by polyaddition to give a prepolymer. For this reaction 0.2 mol (171.96 g) of polytetramethylene oxide-di-p-aminobenzene is charged to a round-bottomed flask with gas inlet, condenser, and stirrer, and this initial charge is dried at 100° C. under a high vacuum for 1 hour with stirring. It is subsequently blanketed with nitrogen and cooled to 40° C. This is followed by the rapid addition of 0.15 mol (37.5 g) of diphenyl 4,4′-diisocyanate. After about 15 minutes the solution, which quickly becomes homogeneous, exhibits a gently exothermic reaction; the temperature rises to 47° C. At the same time there is a sharp rise in the viscosity, so that the reaction mixture solidifies to form an unstirrable, slightly elastic mass. Reaction of the reaction mixture continues at 100° C. for an hour, and then it is cooled to room temperature. The substance, which can no longer be melted, is cooled with liquid nitrogen and ground. The product takes the form of a fine, pale yellow powder which is soluble in acetone and has an amine number of 26.8 (additive 2).

Adhesive Formulation:

8 g of resin (see base formula)

2 g of additive 2

6.3 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 21.8 N/mm | 23.0 N/mm | 23.3 N/mm | 11.8 N/mm |
| strength | | | | |

| | Room temperature | 80° C. |
|---|---|---|
| Tensile shear strength | 15.2 N/mm² | 12.7 N/mm² |

| | Room temperature |
|---|---|
| Peel strength | 7.4 N/mm |

### Example 3

Additive Synthesis:

Dimer fatty acid (AN 190) and polytetrahydrofuran 650 are reacted by polycondensation to give a prepolymer. In a round-bottomed flask with gas blanketing, thermometer, and condenser with water separators, 0.05 mol (29.5 g) of dimer fatty acid, 0.1 mol (63 g) of polytetrahydrofuran, 0.3 g of Swedcat 3 catalyst, and 50 ml of xylene solvent are heated to 140° C. under nitrogen blanketing. Distillative removal of the xylene raises the internal temperature to 195° C., the oil bath temperature being 220° C. The reaction proceeds until water of reaction is no longer formed in the water separator. After about 8 hours, cooling takes place to 180° C. and the water separator is removed and replaced by a descending condenser. Under vacuum, the remaining xylene and volatiles are removed from the reaction mixture over the course of 30 minutes. Lastly the reaction mixture was cooled to 100° C. and the liquid product discharged. At room temperature the product is a deep yellow, is honey-like, and has a OH number of 56 (additive 3).

Adhesive Formulation:

8 g of resin (see base formula)

2 g of additive 3

6.47 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 18.7 N/mm | 23.5 N/mm | 17.5 N/mm | 15.3 N/mm |
| strength | | | | |

| | Room temperature | 80° C. |
|---|---|---|
| Tensile shear strength | 16.9 N/mm² | 14.8 N/mm² |

| | Room temperature |
|---|---|
| Peel strength | 2.9 N/mm |

### Example 4

Additive Synthesis:

Polytetrahydrofuran 650 and diphenyl 4,4′-diisocyanate are reacted by polyaddition to give a prepolymer. For this reaction 0.15 mol (94.5 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.10 mol (25.0 g) of diphenyl 4,4′-diisocyanate. After about 15 minutes the solution, which quickly becomes homogeneous, exhibits a gently exothermic reaction; the temperature rises to 67° C. At the same time there is an increase in the viscosity of the reaction mixture, which remains stirrable. For complete after-reaction, the reaction mixture is stirred at 80° C. for a further 3 hours. Lastly it is cooled to 40° C. and the product is discharged. It takes the form at room temperature of a colorless, non-fluid resin and has an OH number of 48 (additive 4).

Adhesive Formulation:

8 g of resin (see base formula)

2 g of additive 4

6.42 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 28.5 N/mm | 24.7 N/mm | 21.8 N/mm | 16.3 N/mm |
| strength | | | | |

| | Room temperature | 80° C. |
|---|---|---|
| Tensile shear strength | 16.8 N/mm² | 14.4 N/mm² |

| | Room temperature |
|---|---|
| Peel strength | 3.1 N/mm |

### Example 5

Additive Synthesis:

Polytetrahydrofuran 2000 and diphenyl 4,4′-diisocyanate are reacted by polyaddition to give a prepolymer. For this reaction 0.05 mol (101.3 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.025 mol (6.25 g) of diphenyl 4,4′-diisocyanate. After about 15 minutes the solution, which quickly becomes homogeneous, exhibits a gently exothermic reaction; the temperature rises to 67° C. At the same time there is an increase in the viscosity of the reaction mixture, which remains stirrable. For complete after-reaction, the reaction mixture is stirred at 80° C. for a further 3 hours. Lastly it is cooled to 40° C. and the product is discharged. It takes the form at room temperature of a white, slightly waxy or rubber-like resin and has an OH number of 44 (additive 5).

Adhesive Formulation:

8 g of resin (see base formula)

2 g of additive 5

6.31 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 26.0 N/mm | 19.3 N/mm | 22.7 N/mm | 22.8 N/mm |
| strength | | | | |

| | Room temperature | 80° C. |
|---|---|---|
| Tensile shear strength | 15.2 N/mm² | 15.5 N/mm² |

| | Room temperature |
|---|---|
| Peel strength | 4.1 N/mm |

### Example 6

Additive Synthesis:

Polytetrahydrofuran 650 and diphenyl 4,4′-diisocyanate are reacted by polyaddition to give a prepolymer. For this reaction 0.01 mol (64.9 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.08 mol (20 g) of diphenyl 4,4′-diisocyanate. After about 15 minutes the solution, which quickly becomes homogeneous, exhibits an exothermic reaction; the temperature rises to 90° C. At the same time there is an increase in the viscosity of the reaction mixture. For complete after-reaction, the reaction mixture is heated at 80° C. without stirring for a further 3 hours. Lastly it is cooled to 40° C. and the product is discharged. It takes the form at room temperature of a white, rubber-like, gelatinous resin and is meltable. It has an OH number of 26 (additive 6).

Adhesive Formulation:

8 g of resin (see base formula)

2 g of additive 6

6.30 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 19.3 N/mm | 23.5 N/mm | 19.7 N/mm | 14.5 N/mm |
| strength | | | | |

| | Room temperature | 80° C. |
|---|---|---|
| Tensile shear strength | 15.3 N/mm² | 14.8 N/mm² |

| | Room temperature |
|---|---|
| Peel strength | 5.5 N/mm |

### Example 7

Additive Synthesis:

Polytetrahydrofuran 650 and diphenyl 4,4′-diisocyanate are reacted by polyaddition to give a prepolymer. For this reaction 0.14 mol (90.9 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.12 mol (30 g) of diphenyl 4,4′-diisocyanate. After about 15 minutes the solution, which quickly becomes homogeneous, exhibits an exothermic reaction; the temperature rises to 90° C. At the same time there is an increase in the viscosity of the reaction mixture. For complete after-reaction, the reaction mixture is heated at 80° C. without stirring for a further 3 hours. Lastly it is cooled to 40° C. and the product is discharged. It takes the form at room temperature of a tacky, rubber-like, gelatinous resin and is no longer fluid when hot. It has an OH number of 18.5 (additive 7).

Adhesive Formulation:

8 g of resin (see base formula)

2 g of additive 7

6.26 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 16.8 N/mm | 17.8 N/mm | 19.1 N/mm | 15.0 N/mm |
| strength | | | | |

| | Room temperature | 80° C. |
|---|---|---|
| Tensile shear strength | 15.3 N/mm² | 15.4 N/mm² |

| | Room temperature |
|---|---|
| Peel strength | 5.5 J |

### Example 8

Additive Synthesis:

Polytetrahydrofuran 650 and diphenyl 4,4′-diisocyanate are reacted by polyaddition to give a prepolymer. For this reaction 0.09 mol (58.4 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.08 mol (20 g) of diphenyl 4,4′-diisocyanate. After about 15 minutes the solution, which quickly becomes homogeneous, exhibits an exothermic reaction; the temperature rises to 95° C. At the same time there is an increase in the viscosity of the reaction mixture. For complete after-reaction, the reaction mixture is heated at 80° C. without stirring for a further 3 hours. Lastly it is cooled to 40° C. and the product is discharged. It takes the form at room temperature of a tacky, rubber-like, gelatinous resin and is no longer fluid when hot. It has an OH number of 14.3 (additive 8).

Adhesive Formulation:

8 g of resin (see base formula)

2 g of additive 8

6.23 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 28.5 N/mm | 28.0 N/mm | 26.8 N/mm | 22.0 N/mm |
| strength | | | | |

| | Room temperature | 80° C. |
|---|---|---|
| Tensile shear strength | 15.7 N/mm² | 13.9 N/mm² |

| | Room temperature |
|---|---|
| Peel strength | 5.8 N/mm |

### Example 9

Additive Synthesis:

Polytetrahydrofuran 1000 and diphenyl 4,4′-diisocyanate are reacted by polyaddition to give a prepolymer. For this reaction 0.09 mol (97.1 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.06 mol (15 g) of diphenyl 4,4′-diisocyanate. After about 15 minutes the solution, which quickly becomes homogeneous, exhibits a gently exothermic reaction; the temperature rises to 40° C. At the same time there is an increase in the viscosity of the reaction mixture, which just remains still stirrable. For complete after-reaction, the reaction mixture is stirred at 80° C. for a further 3 hours. Lastly it is cooled to 40° C. and the product is discharged. It takes the form at room temperature of a white, highly viscous, rubber-like resin. It has an OH number of 30 (additive 9).

Adhesive Formulation:

8 g of resin (see base formula)

2 g of additive 9

6.32 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 20.3 N/mm | 17.5 N/mm | 16.8 N/mm | 14.3 N/mm |
| strength | | | | |

| | Room temperature | 80° C. |
|---|---|---|
| Tensile shear strength | 16.8 N/mm² | 14.4 N/mm² |

| | Room temperature |
|---|---|
| Peel strength | 5.0 N/mm |

### Example 10

Additive Synthesis:

Polytetrahydrofuran 1000 and diphenyl 4,4′-diisocyanate are reacted by polyaddition to give a prepolymer. For this reaction 0.1 mol (107.9 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.08 mol (20 g) of diphenyl 4,4′-diisocyanate. After about 15 minutes the solution, which quickly becomes homogeneous, exhibits a gently exothermic reaction; the temperature rises to 40° C. At the same time there is an increase in the viscosity of the reaction mixture, which just remains still stirrable. For complete after-reaction, the reaction mixture is stirred at 80° C. for a further 3 hours. Lastly it is cooled to 40° C. and the product is discharged. It takes the form at room temperature of a white, rubber-like resin and is still fluid when hot. It has an OH number of 17.5 (additive 10).

Adhesive Formulation:

8 g of resin (see base formula)

2 g of additive 10

6.25 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 18.7 N/mm | 22.5 N/mm | 17.8 N/mm | 16.0 N/mm |
| strength | | | | |

| | Room temperature | 80° C. |
|---|---|---|
| Tensile shear strength | 15.9 N/mm² | 15.5 N/mm² |

| | Room temperature |
|---|---|
| Peel strength | 5.6 N/mm |

### Example 11

Additive Synthesis:

Polytetrahydrofuran 1000 and diphenyl 4,4′-diisocyanate are reacted by polyaddition to give a prepolymer. For this reaction 0.07 mol (75.5 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.06 mol (15 g) of diphenyl 4,4′-diisocyanate. After about 15 minutes the solution, which quickly becomes homogeneous, exhibits a gently exothermic reaction; the temperature rises to 40° C. At the same time there is an increase in the viscosity of the reaction mixture, which just remains still stirrable. For complete after-reaction, the reaction mixture is stirred at 80° C. for a further 3 hours. Lastly it is cooled to 40° C. and the product is discharged. It takes the form at room temperature of a white, gelatinous resin and is fluid when hot. It has an OH number of 12.4 (additive 11).

Adhesive Formulation:

8 g of resin (see base formula)

2 g of additive 11

6.23 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 24.3 N/mm | 25.0 N/mm | 20.8 N/mm | 14.2 N/mm |
| strength | | | | |

| | Room temperature | 80° C. |
|---|---|---|
| Tensile shear strength | 16.3 N/mm² | 16.4 N/mm² |

| | Room temperature |
|---|---|
| Peel strength | 5.0 N/mm |

### Example 12

Additive Synthesis:

Polytetrahydrofuran 2000 and diphenyl 4,4′-diisocyanate are reacted by polyaddition to give a prepolymer. For this reaction 0.045 mol (91.2 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.03 mol (7.5 g) of diphenyl 4,4′-diisocyanate. After about 15 minutes the solution, which quickly becomes homogeneous, exhibits a gently exothermic reaction; the temperature rises to 35° C. At the same time there is an increase in the viscosity of the reaction mixture, which solidifies gelatinously. For complete after-reaction, the reaction mixture is stirred at 80° C. for a further 3 hours. Lastly it is cooled to 40° C. and the product is discharged. It takes the form at room temperature of a white, gelatinous resin and is still just fluid when hot. It has an OH-number of 17.1 (additive 12).

Adhesive Formulation:

8 g of resin (see base formula)

2 g of additive 12

6.25 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 21.5 N/mm | 25.8 N/mm | 18.7 N/mm | 18.8 N/mm |
| strength | | | | |

| | Room temperature | 80° C. |
|---|---|---|
| Tensile shear strength | 16.2 N/mm² | 15.8 N/mm² |

| | Room temperature |
|---|---|
| Peel strength | 5.3 N/mm |

### Example 13

Additive Synthesis:

Polytetrahydrofuran 2000 and diphenyl 4,4′-diisocyanate are reacted by polyaddition to give a prepolymer. For this reaction 0.04 mol (81.0 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.03 mol (7.5 g) of diphenyl 4,4′-diisocyanate. After about 15 minutes the solution, which quickly becomes homogeneous, exhibits a gently exothermic reaction; the temperature rises to 35° C. At the same time there is an increase in the viscosity of the reaction mixture, which remains barely still stirrable. For complete after-reaction, the reaction mixture is stirred at 80° C. for a further 3 hours. Lastly it is cooled to 40° C. and the product is discharged. It takes the form at room temperature of a white, rigid, barely fluid resin and is meltable again. It has an OH-number of 12.7 (additive 13).

Adhesive Formulation:

8 g of resin (see base formula)

2 g of additive 13

6.23 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 23.8 N/mm | 21.7 N/mm | 20.0 N/mm | 18.5 N/mm |
| strength | | | | |

| | Room temperature | 80° C. |
|---|---|---|
| Tensile shear strength | 16.1 N/mm² | 15.2 N/mm² |

| | Room temperature |
|---|---|
| Peel strength | 5.6 N/mm |

### Example 14

Additive Synthesis:

Polytetrahydrofuran 650 and diphenyl 4,4′-diisocyanate are reacted by polyaddition to give a prepolymer. For this reaction 0.12 mol (78.0 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.11 mol (27.5 g) of diphenyl 4,4′-diisocyanate. After about 15 minutes the solution, which quickly becomes homogeneous, exhibits a gently exothermic reaction; the temperature rises to 57° C. At the same time there is an increase in the viscosity of the reaction mixture. After 20 minutes the mixture is no longer stirrable. For complete after-reaction, the reaction mixture is heated at 80° C. without stirring for a further 3 hours. Lastly it is cooled to 40° C. and the product is discharged. It takes the form at room temperature of a white, solid, rubber-like resin and has an OH number of 10.7 (additive 14).

Adhesive Formulation:

8 g of resin (see base formula)

2 g of additive 14

6.21 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 24.2 N/mm | 22.0 N/mm | 21.3 N/mm | 16.2 N/mm |
| strength | | | | |

| | Room temperature | 80° C. |
|---|---|---|
| Tensile shear strength | 14.8 N/mm² | 15.0 N/mm² |

| | Room temperature |
|---|---|
| Peel strength | 4.5 N/mm |

### Example 15

Additive Synthesis:

Polytetrahydrofuran 2000 and diphenyl 4,4′-diisocyanate are reacted by polyaddition to give a prepolymer. For this reaction 0.05 mol (101.3 g) of polytetrahydrofuran is charged to a round-bottomed flask with gas inlet, thermometer, condenser, and stirrer, and this initial charge is dried at 100° C. under a high vacuum for 1 hour with stirring. It is subsequently blanketed with nitrogen and cooled to 40° C. This is followed by the rapid addition of 0.04 mol (10.0 g) of diphenyl 4,4′-diisocyanate. After about 15 minutes the solution, which quickly becomes homogeneous, exhibits a gently exothermic reaction; the temperature rises to 55° C. At the same time there is an increase in the viscosity of the reaction mixture. For complete after-reaction, the reaction mixture is heated at 80° C. without stirring for a further 3 hours. Lastly it is cooled to 40° C. and the product is discharged. It takes the form at room temperature of a slightly turbid, rubber-like, non-fluid resin and has an OH number of 10.3 (additive 15).

Adhesive Formulation:

8 g of resin (see base formula)

2 g of additive 15

6.21 g of curing agent (see base formula)

This mixture is stirred intimately and quickly and bonding takes place to cathodically electrocoated specimens.

Results:

| | Room | | | |
|---|---|---|---|---|
| | temperature | 0° C. | −20° C. | −40° C. |
| Impact peel | 17.8 N/mm | 17.3 N/mm | 20.3 N/mm | 19.2 N/mm |
| strength | | | | |

| | Room temperature | 80° C. |
|---|---|---|
| Tensile shear strength | 16.2 N/mm² | 14.7 N/mm² |

| | Room temperature |
|---|---|
| Peel strength | 4.0 N/mm |

### Comparative Experiments

For the purpose of comparison, cathodically electrocoated specimens were bonded in the same way as in the working examples using the TEROKAL 806 N adhesive, in accordance with the base formula without the addition of an additive. Measurement of the impact peel strength gave a figure of 10.6 N/mm.

What is claimed is:

1. A two-component polyurethane adhesive comprising a polyol component and a polyisocyanate component, wherein an adhesive bond produced using the adhesive between two steel panels coated with cathodic electrocoat has, at a temperature of −40° C., an impact peel strength as measured by ISO 11343 of at least 11 N/mm.

2. The adhesive of claim 1, wherein an adhesive bond produced using the adhesive between two steel panels coated with cathodic electrocoat has, at a temperature of −40° C., an impact peel strength as measured by ISO 11343 of at least 15 N/mm.

3. The adhesive of claim 1, comprising at least one reaction product which comprises one or more terminal hydroxyl, amino and/or isocyanate groups and is prepared by reacting a compound having terminal hydroxyl and/or amino groups, of the general formula (I)
H—X—[—CH₂)ₘ—O—]ₙ—X′—H,
in which X is=—O— or 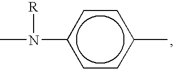
X′ is=a covalent bond or 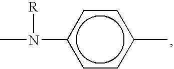
R being=H or a straight-chain or branched alkyl radical having 1 to 20 carbon atoms,
m is=3 or 4, and
n is=5 to 50,
with a reactant selected from the group consisting of dicarboxylic acids, tricarboxylic acids, diisocyanates and triisocyanates.

4. The adhesive of claim 3, wherein the compound of general formula (I) is a polytetrahydrofuran or a polytetramethylene oxide-di-p-amino-benzene.

5. The adhesive of claim 3, wherein said reactant includes dimerized fatty acid.

6. The adhesive of claim 3, wherein said reactant includes diphenyl diisocyanate.

7. The adhesive of claim 3, wherein reaction product is present in the adhesive in an amount of 5% to 30% by weight, based on the total weight of said adhesive.

8. The adhesive of claim 1, comprising at least one reaction product which comprises one or more terminal hydroxyl and/or isocyanate groups and is prepared by reacting a polytetrahydrofuran with a diphenyl diisocyanate.

9. The adhesive of claim 1, comprising at least one reaction product which comprises one or more terminal hydroxyl groups and is prepared by reacting a polytetrahydrofuran with a dimer fatty acid.

10. The adhesive of claim 1, comprising at least one reaction product which comprises one or more terminal amino and/or isocyanate groups and is prepared by reacting a polytetramethylene oxide-di-p-aminobenzene with a diphenyl diisocyanate.

11. An additive for two-component polyurethane adhesives, wherein said additive is a reaction product which comprises one or more terminal hydroxyl, amino and/or isocyanate groups and is prepared by reacting a compound having terminal hydroxyl and/or amino groups, of the general formula (I)
H—X—[—CH₂)ₘ—O—]ₙ—X′—H,
in which X is=—O— or 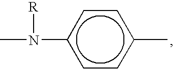
X′ is=a covalent bond or 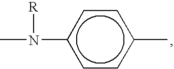
R being=H or a straight-chain or branched alkyl radical having 1 to 20 carbon atoms,
m is=3 or 4, and
n is=5 to 50,
with at least one reactant selected from the group consisting of dicarboxylic acids, tricarboxylic acids, diisocyanates and triisocyanates.

12. The additive of claim 11, wherein said additive has a number-average molecular weight of from 1000 to 20,000 g/mol.

13. The additive of claim 11, wherein said additive has a number-average molecular weight of from 2000 to 8000 g/mol.

14. A method of forming an adhesive bond using an adhesive, said method comprising selecting for use as an additive in said adhesive a reaction product which comprises one or more terminal hydroxyl, amino and/or isocyanate groups and is prepared by reacting a compound having terminal hydroxyl and/or amino groups, of the general formula (I)
H—X—[—CH₂)ₘ—O—]ₙ—X′—H,
in which X is=—O— or 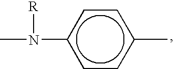
X′ is=a covalent bond or 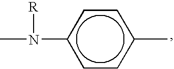
R being=H or a straight-chain or branched alkyl radical having 1 to 20 carbon atoms,
m is=3 or 4, and
n is=5 to 50,
with a reactant selected from the group consisting of dicarboxylic acids, tricarboxylic acids, diisocyanates and triisocyanates.

15. The method of claim 14, wherein said adhesive bond is between a first metal substrate and a second metal substrate.

16. The method of claim 15, wherein at least one of first metal substrate and said second metal substrate has an electrodeposition coating thereon.
